(19) United States
(12) Patent Application Publication
(10) Pub. No.: US 2024/0069506 A1
(43) Pub. Date: Feb. 29, 2024

(54) MANAGEMENT APPARATUS AND MANAGEMENT METHOD

(71) Applicant: TOYOTA JIDOSHA KABUSHIKI KAISHA, Toyota-shi (JP)

(72) Inventors: Atsushi KOMADA, Nagakute-shi (JP); Mitsuru OGASAWARA, Gamagori-shi (JP); Masahiko ISHII, Okazaki-shi (JP); Hidetaka ASANO, Nissin-shi (JP); Tomokazu ISHII, Okazaki-shi (JP); Koji HETSUGI, Toyota-shi (JP); Kosuke YONEKAWA, Nissin-shi (JP); Yoshikazu JIKUHARA, Miyoshi-shi (JP)

(73) Assignee: TOYOTA JIDOSHA KABUSHIKI KAISHA, Toyota-shi (JP)

(21) Appl. No.: 18/230,861

(22) Filed: Aug. 7, 2023

(30) Foreign Application Priority Data
Aug. 31, 2022 (JP) 2022-138075

(51) Int. Cl. G05B 13/04

(52) U.S. Cl. CPC G05B 13/041

(57) ABSTRACT

A management method for managing a CO₂ emission amount to be emitted by producing a product, includes: reading out a first CO₂ emission amount that is a CO₂ emission amount per unit weight of a first raw material and a second CO₂ emission amount that is a CO₂ emission amount per unit weight of a second raw material; and calculating the CO₂ emission amount of the product based on a CO₂ emission amount to be calculated from the first CO₂ emission amount and from a weight of the first raw material used to produce the product, and a CO₂ emission amount to be calculated from the second CO₂ emission amount and from a weight of the second raw material used to produce the product.

### CROSS-REFERENCE TO RELATED APPLICATION

This application claims priority to Japanese Patent Application No. 2022-138075 filed on Aug. 31, 2022, incorporated herein by reference in its entirety.

### BACKGROUND

### 1. Technical Field

The present disclosure relates to a management apparatus and a management method for managing an emission amount of CO₂ emitted by producing a product (hereinafter also simply referred to as “a CO₂ emission amount of a product”).

### 2. Description of Related Art

With growing awareness of environmental issues, there is growing interest in a CO₂ emission amount emitted by producing products that are distributed on the market. In that respect, a company may calculate and manage the CO₂ emission amount emitted by producing the products. For example, Japanese Unexamined Patent Application Publication No. 2016-126372 (JP 2016-126372 A) discloses a method of calculating a CO₂ emission amount in a transportation process of products (including materials and components).

### SUMMARY

A CO₂ emission amount emitted by producing a certain product includes a CO₂ emission amount emitted by producing raw materials used to produce the product. As the CO₂ emission amount of the raw material, a value reported by a supplier (an upstream company in a supply chain) of the raw material is generally used.

Here, some of the raw materials used to produce the product may include recycled products. A CO₂ emission amount of the recycled product is different from a CO₂ emission amount of a regular raw material (hereinafter also referred to as a “regular product”) that is not a recycled product. In a case where some of the raw materials used to produce the product include recycled products, the CO₂ emission amount of the product may not be appropriately calculated when the CO₂ emission amount of the raw material (regular product) reported from the supplier of the raw material (regular product) is used to calculate the CO₂ emission amount of the raw material.

The present disclosure is to accurately calculate a CO₂ emission amount emitted by producing a product.

A first aspect of the present disclosure relates to a management apparatus configured to manage a CO₂ emission amount to be emitted by producing a product. The management apparatus includes a storage device and a control device. The storage device stores a first CO₂ emission amount that is a CO₂ emission amount per unit weight of a first raw material and a second CO₂ emission amount that is a CO₂ emission amount per unit weight of a second raw material. The control device is configured to calculate the CO₂ emission amount of the product based on a CO₂ emission amount to be calculated from the first CO₂ emission amount and from a weight of the first raw material used to produce the product, and a CO₂ emission amount to be calculated from the second CO₂ emission amount and from a weight of the second raw material used to produce the product. The product is produced by using the first raw material and the second raw material that are the same kind of raw materials. The first raw material is not a recycled product produced by recycling. The second raw material is the recycled product.

According to the configuration, the CO₂ emission amount of the product is calculated in consideration of the CO₂ emission amount of the second raw material that is the recycled product as well as the CO₂ emission amount of the first raw material that is not the recycled product. With this, in a case where the product is produced using, as raw materials, the first raw material (regular product) and the second raw material (recycled product) that are the same kind of raw materials, the CO₂ emission amount of the product can be appropriately calculated.

In the aspect of the present disclosure, the second CO₂ emission amount may be calculated based on an amount of energy required to produce the second raw material by recycling.

According to the configuration, the CO₂ emission amount in a recycling process for producing the second raw material can be appropriately reflected in the second CO₂ emission amount. Therefore, the CO₂ emission amount of the product can be accurately calculated.

In the aspect of the present disclosure, the control device may be configured to calculate the second CO₂ emission amount as zero in a case where the recycling to produce the second raw material does not involve CO₂ emission.

According to the configuration, in a case where the recycling does not involve CO₂ emission, the second CO₂ emission amount can be calculated as zero. Therefore, utilization of recycling that does not involve CO₂ emission can be promoted. In addition, the CO₂ emission amount in the recycling process for producing the second raw material can be appropriately reflected.

A second aspect of the present disclosure relates to a management method for managing a CO₂ emission amount to be emitted by producing a product. The management method includes reading out a first CO₂ emission amount that is a CO₂ emission amount per unit weight of a first raw material and a second CO₂ emission amount that is a CO₂ emission amount per unit weight of a second raw material, and calculating the CO₂ emission amount of the product based on a CO₂ emission amount to be calculated from the first CO₂ emission amount and from a weight of the first raw material used to produce the product, and a CO₂ emission amount to be calculated from the second CO₂ emission amount and from a weight of the second raw material used to produce the product. The product is produced by using the first raw material and the second raw material that are the same kind of raw materials. The first raw material is not a recycled product produced by recycling. The second raw material is the recycled product.

According to the present disclosure, a CO₂ emission amount emitted by producing a product can be accurately calculated.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is an overall configuration diagram of a management system according to an embodiment;

FIG. 2 is a functional block diagram of a control device; and

FIG. 3 is a flowchart showing a procedure of processing that is used to calculate a unit CO₂ emission amount Qc of a product and that is executed by the control device.

### DETAILED DESCRIPTION OF EMBODIMENTS

Hereinafter, an embodiment of the present disclosure will be described in detail with reference to the drawings. In the drawings, the same or corresponding parts are denoted by the same reference numerals, and the description thereof will not be repeated.

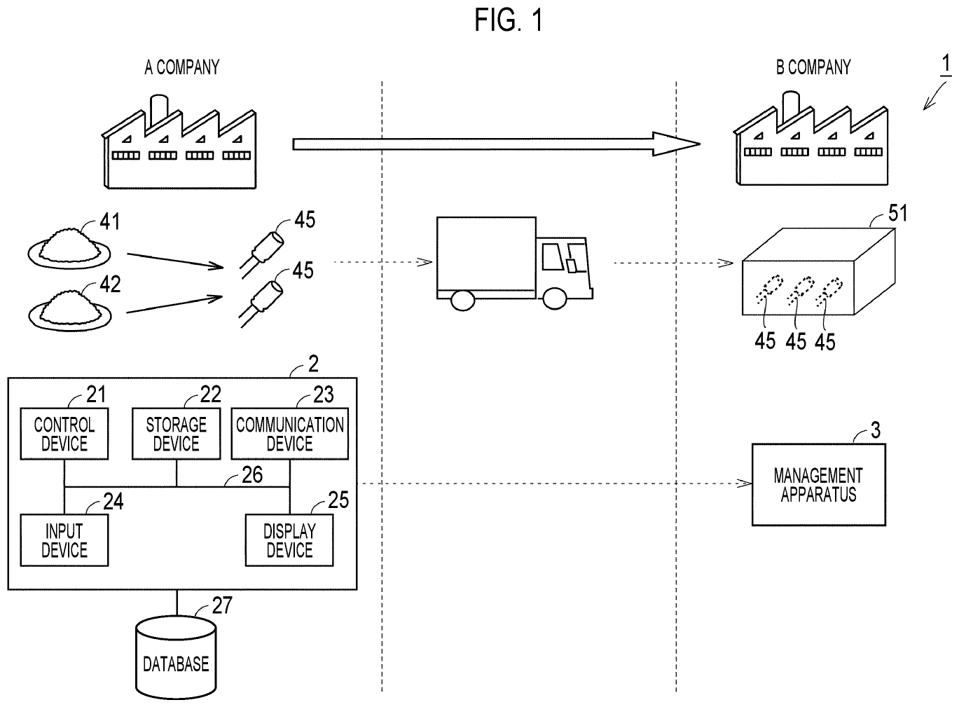

FIG. 1 is an overall configuration diagram of a management system 1 according to the present embodiment. The management system 1 is a system for managing a CO₂ emission amount emitted by producing a product. The management system 1 includes a management apparatus 2 belonging to an A company and a management apparatus 3 belonging to a B company. The A company and the B company form a supply chain. The A company is an upstream company of the B company in the supply chain. The A company delivers, to the B company, a product 45 that is an A company's own product. In the present embodiment, the product 45 is an electronic component. Note that the product 45 is not limited to being an electronic component. The product 45 may be various raw materials. The raw material is an article to be used in a production process of the product. The product 45 may be, for example, a component of an automobile, such as an engine and a door. The product 45 corresponds to an example of a “product” according to the present disclosure.

The management apparatus 2 of the A company manages a CO₂ emission amount (a CO₂ emission amount of the product 45) emitted by producing the product 45. The CO₂ emission amount of the product 45 includes a CO₂ emission amount of raw materials (raw materials 41, 42 in the example to be described below in the present embodiment) used to produce the product 45, and a CO₂ emission amount required to produce the product 45 using the raw materials (in other words, a CO₂ emission amount emitted in a process of producing the product 45 using the raw materials).

In the present embodiment, the A company uses the raw materials 41, 42 to produce the product 45. In the present embodiment, the raw materials 41, 42 are the same kind of raw materials. The raw material 41 is a new product that is not a recycled product (hereinafter also referred to as a “regular product”), and the raw material 42 is a recycled product. The recycled product means a reclaimed product and is a product produced by processing a molded article through a predetermined method. The raw material 41 corresponds to an example of a “first raw material” according to the present disclosure. The raw material 42 corresponds to an example of a “second raw material” according to the present disclosure.

In the present embodiment, the A company purchases the raw material 41 for producing the product 45 from a C company (not shown) that is an upstream company in the supply chain. For example, when the raw material 41 is delivered, the A company receives, from the upstream company (C company), a report of a CO₂ emission amount (a CO₂ emission amount of the raw material 41) emitted by producing the raw material 41 and stores this. The CO₂ emission amount of the raw material 41 may include a CO₂ emission amount emitted by transporting the raw material 41 from the C company to the A company.

In addition, the A company purchases the raw material 42 for producing the product 45 from a D company (not shown) that is an upstream company in the supply chain. For example, when the raw material 42 is delivered, the A company receives, from the upstream company (D company), a report of a CO₂ emission amount (a CO₂ emission amount of the raw material 42) emitted by producing the raw material 42 and stores this. The CO₂ emission amount of the raw material 42 may include a CO₂ emission amount emitted by transporting the raw material 42 from the D company to the A company. The A company may produce the raw material 42 by recycling. In this case, the A company calculates a CO₂ emission amount required to produce the raw material 42 by recycling, and stores this as the CO₂ emission amount of the raw material 42. The CO₂ emission amount required to produce the raw material 42 by recycling is calculated based on, for example, an amount of energy required to produce the raw material 42 by recycling.

The management apparatus 2 includes a control device 21, a storage device 22, a communication device 23, an input device 24, and a display device 25. The control device 21, the storage device 22, the communication device 23, the input device 24, and the display device 25 are connected to a bus 26. In addition, a database 27 is communicably connected to the management apparatus 2.

The control device 21 is configured by, for example, an integrated circuit including a central processing unit (CPU). The control device 21 executes various programs stored in the storage device 22. Various programs include an operating system and the like. The storage device 22 includes, for example, a read only memory (ROM) that stores the various programs, and a random access memory (RAM) that functions as a working memory and that temporarily stores various kinds of data necessary for executing the various programs.

In addition to the various programs, the storage device 22 further stores a conversion equation (conversion information) for converting a power consumption amount into a CO₂ emission amount. In the conversion equation, for example, the power consumption amount may be multiplied by a CO₂ emission coefficient. The CO₂ emission coefficient is provided from, for example, a power provider (a power company). The conversion equation stored in the storage device 22 is updated by the control device 21, for example, when the CO₂ emission coefficient is updated.

The communication device 23 is configured to communicate with the management apparatus 3. Communication between the communication device 23 and the management apparatus 3 is performed via, for example, the Internet. In addition, the communication device 23 is configured to communicate with management apparatuses (both not shown) of upstream companies (in the example, the C company and the D company) in the supply chain. Communication between the communication device 23 and the management apparatus of the upstream company is performed via, for example, the Internet.

The input device 24 includes an input device. The input device is, for example, a mouse, a keyboard, a touch panel, and/or other devices capable of accepting user operations.

The display device 25 includes a display. The display device 25 displays various images on the display in accordance with a control signal from the control device 21. The display is, for example, a liquid crystal display, an organic electro luminescence (EL) display, or other display devices.

The database 27 stores information in accordance with a control signal from the management apparatus 2 (control device 21). The database 27 can also be provided as a storage device in the management apparatus 2.

The control device 21 causes the database 27 to store the CO₂ emission amount of the raw material 41 received from the upstream company (C company) in the supply chain. The CO₂ emission amount of the raw material 41 is the CO₂ emission amount required to produce the raw material 41 (the CO₂ emission amount emitted by producing the raw material 41). The CO₂ emission amount of the raw material 41 may also include a CO₂ emission amount of a raw material used to produce the raw material 41. The CO₂ emission amount of the raw material 41 received from the upstream company may be a CO₂ emission amount per delivery unit of the raw material 41, a CO₂ emission amount per unit number of the raw material 41, or a CO₂ emission amount per unit weight of the raw material 41. In the present embodiment, as described above, it is assumed that the raw material 41 is a raw material. Therefore, in the present embodiment, it is assumed that the CO₂ emission amount of the raw material 41 received from the upstream company is a unit CO₂ emission amount Qn that is the CO₂ emission amount per unit weight of the raw material 41. In a case where the CO₂ emission amount per delivery unit of the raw material 41 is received, the control device 21 need only calculate the unit CO₂ emission amount Qn by dividing the CO₂ emission amount per delivery unit by the weight per delivery unit. Then, the control device 21 causes the database 27 to store the unit CO₂ emission amount Qn.

In addition, the control device 21 causes the database 27 to store the CO₂ emission amount of the raw material 42 received from the upstream company (D company) in the supply chain. The CO₂ emission amount of the raw material 42 is the CO₂ emission amount required to produce the raw material 42 by recycling. The CO₂ emission amount of the raw material 42 may be calculated based on, for example, the amount of energy required for recycling. For example, in a case where the recycling process does not involve CO₂ emission, such as a case where a molded article can be used as the raw material 42 as it is, the CO₂ emission amount of the raw material 42 can be set to zero. The CO₂ emission amount of the raw material 42 received from the upstream company may be a CO₂ emission amount per delivery unit of the raw material 42, a CO₂ emission amount per unit number of the raw material 42, or a CO₂ emission amount per unit weight of the raw material 42. In the present embodiment, as described above, it is assumed that the raw material 42 is a raw material. Therefore, in the present embodiment, it is assumed that the CO₂ emission amount of the raw material 42 received from the upstream company is a unit CO₂ emission amount Qr that is the CO₂ emission amount per unit weight of the raw material 42. In a case where the CO₂ emission amount per delivery unit of the raw material 42 is received, the control device 21 need only calculate the unit CO₂ emission amount Qr by dividing the CO₂ emission amount per delivery unit by the weight per delivery unit. Then, the control device 21 causes the database 27 to store the unit CO₂ emission amount Qr. In a case where recycling is performed in the A company, the control device 21 calculates the unit CO₂ emission amount Qr based on an amount of energy consumed in the recycling process, and causes the database 27 to store the calculated unit CO₂ emission amount Qr. It is also possible to provide another device of the A company with the function of calculating the unit CO₂ emission amount Qr. In this case, the control device 21 may acquire the unit CO₂ emission amount Qr from the other device via the communication device 23, or may acquire the unit CO₂ emission amount Qr input by an employee of the A company from the input device 24.

The control device 21 uses the unit CO₂ emission amount Qn and the unit CO₂ emission amount Qr to calculate a unit CO₂ emission amount Qc that is the CO₂ emission amount per unit number of the product 45. A method for calculating the unit CO₂ emission amount Qc will be described below in detail. The control device 21 reports the unit CO₂ emission amount Qc to the management apparatus 3 of the B company via the communication device 23.

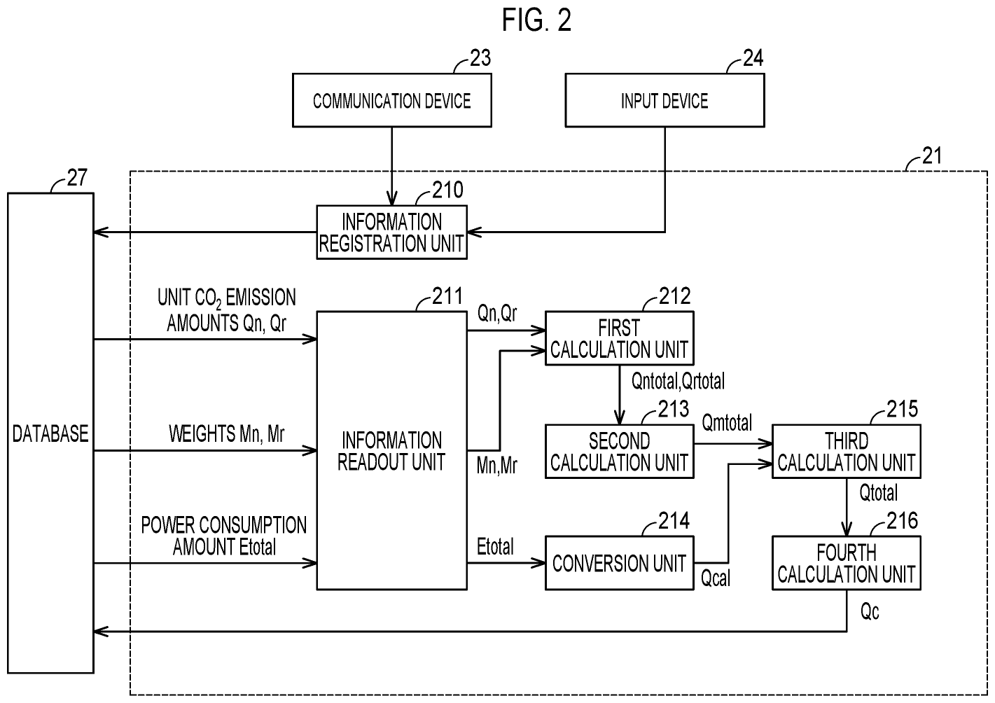

FIG. 2 is a functional block diagram of the control device 21. The control device 21 includes an information registration unit 210, an information readout unit 211, a first calculation unit 212, a second calculation unit 213, a conversion unit 214, a third calculation unit 215, and a fourth calculation unit 216. The control device 21 executes, for example, the programs stored in the storage device 22 to function as the information registration unit 210, the information readout unit 211, the first calculation unit 212, the second calculation unit 213, the conversion unit 214, the third calculation unit 215, and the fourth calculation unit 216. The information registration unit 210, the information readout unit 211, the first calculation unit 212, the second calculation unit 213, the conversion unit 214, the third calculation unit 215, and the fourth calculation unit 216 may be realized by, for example, dedicated hardware (electrical circuit).

The information registration unit 210 causes the database 27 to store various kinds of information. The information registration unit 210 causes the database 27 to store the unit CO₂ emission amount Qn of the raw material 41 acquired from the upstream company via, for example, the communication device 23. In addition, the information registration unit 210 causes the database 27 to store the unit CO₂ emission amount Qr of the raw material 42 acquired from the upstream company via, for example, the communication device 23. Alternatively, in a case where recycling is performed in the A company, the information registration unit 210 acquires the unit CO₂ emission amount Qr input by the employee of the A company from the input device 24 and causes the database 27 to store the unit CO₂ emission amount Qr. In a case where the recycling process does not involve CO₂ emission, such as a case where a molded article can be used as the raw material 42 as it is, the unit CO₂ emission amount Qr is set to zero.

Further, the information registration unit 210 acquires a weight Mn of the raw material 41 used and a weight Mr of the raw material 42 used in producing the product and causes the database 27 to store the weights Mn, Mr. The weight Mn of the raw material 41 and the weight Mr of the raw material 42 used to produce the product 45 are input to the input device 24 by, for example, the employee of the A company. The information registration unit 210 acquires the weights Mn, Mr from the input device 24. Alternatively, the weight Mn of the raw material 41 and the weight Mr of the raw material 42 used to produce the product 45 may be acquired from another device of the A company via the communication device 23. In the present embodiment, the product 45 is produced in a predetermined lot unit including a predetermined number of products 45. Therefore, the weight Mn of the raw material 41 and the weight Mr of the raw material 42 are a weight of the raw material 41 and a weight of the raw material 42 used to produce a predetermined lot including the predetermined number of products 45 (hereinafter also referred to as a “product lot 46”).

In addition, the information registration unit 210 acquires an amount of power (power consumption amount Etotal) consumed in a production line (not shown) for producing the product lot 46. The power consumption amount Etotal may be measured by a power meter (not shown) provided in the production line, or may be measured by the management apparatus 2. The power consumption amount Etotal may be, for example, power consumed in a factory building in which the production line is installed. The power consumed in the factory building may include power used to operate all equipment related to the production of the products, for example, air conditioning, lighting, component conveying vehicles (forklifts, and the like), production line conveyors, impact wrenches, and assembly devices. For example, in a case where a plurality of production lines is installed in the factory building, power consumed in a production line may be set to include power used to operate equipment related to the production of products produced on the production line and not to include power used to operate equipment related to the production of products produced on other production lines. The information registration unit 210 causes the database 27 to store the power consumption amount Etotal.

The information readout unit 211 reads out various kinds of information from the database 27. The information readout unit 211 reads out the unit CO₂ emission amount Qn of the raw material 41 and the unit CO₂ emission amount Qr of the raw material 42 from the database 27. The information readout unit 211 outputs the unit CO₂ emission amounts Qn, Qr to the first calculation unit 212.

In addition, the information readout unit 211 reads out, from the database 27, the weight Mn of the raw material 41 and the weight Mr of the raw material 42 used to produce the product lot 46. The information readout unit 211 outputs the weights Mn, Mr to the first calculation unit 212.

Further, the information readout unit 211 reads out the power consumption amount Etotal from the database 27. The information readout unit 211 outputs the power consumption amount Etotal to the conversion unit 214.

The first calculation unit 212 calculates a CO₂ emission amount Qntotal of the raw material 41 used to produce the product lot 46 from the unit CO₂ emission amount Qn and the weight Mn of the raw material 41. Specifically, the first calculation unit 212 calculates the CO₂ emission amount Qntotal in accordance with Equation (1). In addition, the first calculation unit 212 calculates a CO₂ emission amount Qrtotal of the raw material 42 used to produce the product lot 46 from the unit CO₂ emission amount Qr and the weight Mr of the raw material 42. Specifically, the first calculation unit 212 calculates the CO₂ emission amount Qrtotal in accordance with Equation (2).

Qntotal=Qn×Mn (1)

Qrtotal=Qr×Mr (2)

The first calculation unit 212 outputs the calculated CO₂ emission amounts Qntotal, Qrtotal to the second calculation unit 213.

The second calculation unit 213 adds the CO₂ emission amount Qntotal and the CO₂ emission amount Qrtotal to calculate a CO₂ emission amount Qmtotal that is the sum of the CO₂ emission amounts of the raw materials (the raw material 41 and the raw material 42) used to produce the product lot 46. Specifically, the second calculation unit 213 calculates the CO₂ emission amount Qmtotal in accordance with Equation (3).

Qmtotal=Qntotal+Qrtotal (3)

The second calculation unit 213 outputs the calculated CO₂ emission amount Qmtotal to the third calculation unit 215.

The conversion unit 214 reads out the conversion equation from the storage device 22. The conversion unit 214 inputs the power consumption amount Etotal into the conversion equation to calculate a CO₂ emission amount Qcal emitted in the production line in producing the product lot 46. The conversion unit 214 outputs the CO₂ emission amount Qcal to the third calculation unit 215.

The third calculation unit 215 adds the CO₂ emission amount Qmtotal and the CO₂ emission amount Qcal to calculate a CO₂ emission amount (the CO₂ emission amount of the product lot 46) Qtotal emitted by producing the product lot 46. Specifically, the third calculation unit 215 calculates the CO₂ emission amount Qtotal in accordance with Equation (4).

Qtotal=Qmtotal+Qcal (4)

The third calculation unit 215 outputs the calculated CO₂ emission amount Qtotal to the fourth calculation unit 216.

The fourth calculation unit 216 divides the CO₂ emission amount Qtotal by a predetermined number N that is the number of products 45 included in the product lot 46 to calculate the unit CO₂ emission amount Qc that is the CO₂ emission amount per unit number of the product 45. Specifically, the fourth calculation unit 216 calculates the unit CO₂ emission amount Qc in accordance with Equation (5). The predetermined number N can be stored in the database 27 in advance.

Qc=Qtotal/N (5)

The fourth calculation unit 216 causes the database 27 to store the calculated unit CO₂ emission amount Qc. Each product 45 is given an identification number. The fourth calculation unit 216 links the unit CO₂ emission amount Qc to the identification number of each product 45 and causes the database 27 to store the unit CO₂ emission amount Qc and the identification number of each product 45.

The unit CO₂ emission amount Qc stored in the database 27 is transmitted to the management apparatus 3 of the B company, for example, in response to a request from the B company or when the product 45 is delivered to the B company. With this, the CO₂ emission amount of the product 45 is reported to the B company. When the product is delivered to the B company, the control device 21 uses the identification number of the product 45 delivered to the company as a key to read out the unit CO₂ emission amount Qc of the product 45 from the database 27. Then, the control device 21 outputs, to the communication device 23, a control signal for transmitting, to the management apparatus 3 of the B company, the unit CO₂ emission amount Qc of the product 45 delivered to the B company, together with information for specifying the product 45. With this, the information for specifying the product 45 delivered to the B company and information on the unit CO₂ emission amount Qc of the product 45 are reported to the B company via the communication device 23. The information for specifying the product 45 delivered to the B company need only be information for allowing the B company to specify which product the reported unit CO₂ emission amount Qc belongs to, and may be, for example, the identification number or a delivery number written on a delivery slip or the like.

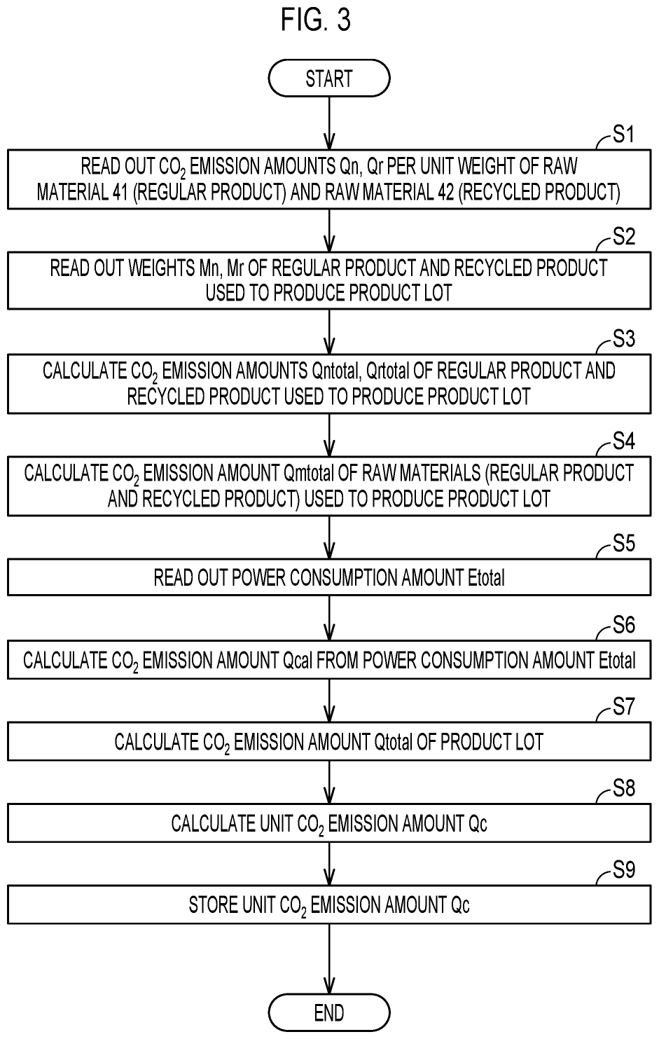

FIG. 3 is a flowchart showing a procedure of processing that is used to calculate the unit CO₂ emission amount Qc of the product 45 and that is executed by the control device 21. The flowchart is executed by the control device 21 when the production of the product lot 46 is completed. A case where each step (hereinafter, the step is abbreviated as “S”) of the flowchart shown in FIG. 3 is realized by software processing executed by the control device 21 will be described, but a part or all thereof may be realized by hardware (electrical circuit) produced in the control device 21.
In S1, the control device 21 reads out, from the database 27, the unit CO₂ emission amount Qn of the raw material 41 (regular product) used to produce the product lot 46 and the unit CO₂ emission amount Qr of the raw material 42 (recycled product) used to produce the product lot 46.
In S2, the control device 21 reads out the weight Mn of the raw material 41 (regular product) used to produce the product lot 46 and the weight Mr of the raw material 42 (recycled product) used to produce the product lot 46.
In S3, the control device 21 calculates the CO₂ emission amount Qntotal of the raw material 41 used to produce the product lot 46 and the CO₂ emission amount Qrtotal of the raw material 42 used to produce the product lot 46 in accordance with Equations (1), (2), respectively.
In S4, the control device 21 calculates the CO₂ emission amount Qmtotal that is the sum of the CO₂ emission amounts of the raw materials (the raw material 41 and the raw material 42) used to produce product lot 46 in accordance with Equation (3).
In S5, the control device 21 reads out the power consumption amount Etotal from the database 27. At the timing of S5, the control device 21 may be configured to acquire the power consumption amount Etotal from the power meter provided in the production line.
In S6, the control device 21 reads out the conversion equation from the storage device 22. The control device 21 inputs the power consumption amount Etotal into the conversion equation to calculate the CO₂ emission amount Qcal emitted in the production line in producing the product lot 46.
In S7, the control device 21 calculates the CO₂ emission amount Qtotal of the product lot 46 in accordance with Equation (4).
In S8, the control device 21 reads out, from the database 27, the predetermined number N that is the number of products 45 included in the product lot 46. Then, the control device 21 calculates the unit CO₂ emission amount Qc of the product 45 in accordance with Equation (5).
In S9, the control device 21 links the unit CO₂ emission amount Qc to the identification number of each product 45 and causes the database 27 to store the unit CO₂ emission amount Qc and the identification number of each product 45.

As described above, the management apparatus 2 according to the present embodiment calculates the unit CO₂ emission amount Qc of the product 45 produced using the raw material 41 that is a regular product and the raw material 42 that is a recycled product as raw materials, by using the CO₂ emission amount Qntotal of the raw material 41 calculated from the unit CO₂ emission amount Qn per unit weight of the raw material 41 and from the weight Mn of the raw material 41 used, and the CO₂ emission amount Qrtotal of the raw material 42 calculated from the unit CO₂ emission amount Qr per unit weight of the raw material 42 and from the weight Mr of the raw material 42 used. The management apparatus 2 adds the CO₂ emission amount Qntotal and the CO₂ emission amount Qrtotal to calculate the CO₂ emission amount Qmtotal of the raw materials (the raw material 41 and the raw material 42) used to produce the product lot 46, and adds the CO₂ emission amount Qcal calculated based on the power consumption amount Etotal to the calculated CO₂ emission amount Qmtotal to calculate the CO₂ emission amount Qtotal of the product lot 46. The management apparatus 2 divides the CO₂ emission amount Qtotal by the number of the products 45 included in the product lot 46 to calculate the unit CO₂ emission amount Qc of the product 45. In this way, the management apparatus 2 calculates the unit CO₂ emission amount Qc of the product 45 in consideration of the CO₂ emission amount Qrtotal of the raw material 42 that is a recycled product. As a result, in a case where the product 45 is produced using, as raw materials, a regular product and a recycled product that are the same kind of raw materials, the unit CO₂ emission amount Qc of the product 45 can be appropriately calculated.

In addition, the unit CO₂ emission amount Qc of the product 45 calculated as described above is reported to the B company, so that the B company can acquire the unit CO₂ emission amount Qc of the product 45 in which the CO₂ emission amount Qrtotal of the recycled product has been taken into consideration.

Further, the unit CO₂ emission amount Qr per unit weight of the raw material 42 that is a recycled product is determined based on the CO₂ emission amount required to produce the raw material 42 by recycling. The unit CO₂ emission amount Qr is used as the unit CO₂ emission amount Qc of the product 45, so that the CO₂ emission amount in the recycling process can be appropriately reflected in the unit CO₂ emission amount Qc. Accordingly, the unit CO₂ emission amount Qc can be appropriately calculated.

Furthermore, in a case where recycling does not involve CO₂ emission, such as a case where the molded article can be used as the raw material 42 as it is, the unit CO₂ emission amount Qr of the raw material 42 is set to zero. As a result, it is possible to promote the recycling of the molded article that does not involve CO₂ emission during recycling. In addition, the CO₂ emission amount in the recycling process can be appropriately reflected in the unit CO₂ emission amount Qc of the product 45. Accordingly, the unit CO₂ emission amount Qc of the product 45 can be appropriately calculated.

### Modification Example 1

In the embodiment, an example has been described in which the unit CO₂ emission amount Qc of the product 45 is reported from the A company to the B company. However, a CO₂ emission amount Qb per delivery unit of the product 45 may be reported from the A company to the B company.

Referring to FIG. 1 again, the product 45 is packed in a packing box 51 and is delivered to the B company. A plurality of products 45 packed in the packing box 51 forms a delivery unit. The control device 21 of the management apparatus 2 reads out the unit CO₂ emission amount Qc from the database 27 and calculates the CO₂ emission amount Qb per delivery unit. For example, even in a case where the products 45 with different product lots are packed in the packing box 51, the control device uses the unit CO₂ emission amount Qc of each of the products to calculate the CO₂ emission amount Qb per delivery unit.

### Modification Example 2

It is also conceivable to form a consortium between companies included in the supply chain and share information between the companies using distributed ledger technology. In this case, the management apparatuses 2, 3 may function as nodes to form a distributed ledger network with nodes of other companies included in the supply chain. For example, the management apparatus 2 (node) transmits, to the distributed ledger network, transaction data including information on the unit CO₂ emission amount Qc of the product 45 to be reported to the B company that is a downstream company. The management apparatus 3 (node) of the B company approves the transaction data, whereby the unit CO₂ emission amount Qc of the product 45 is reported to the downstream company. Using distributed ledger technology to report the CO₂ emission amount can make information more resistant to tampering.

The embodiments disclosed this time should be considered illustrative and not restrictive in all respects. The scope of the present disclosure is indicated by the scope of claims rather than by the above description, and is intended to include all modifications within the scope and meaning equivalent to the scope of the claims.

What is claimed is:

1. A management apparatus configured to manage a CO₂ emission amount to be emitted by producing a product, the management apparatus comprising:
a storage device storing a first CO₂ emission amount that is a CO₂ emission amount per unit weight of a first raw material and a second CO₂ emission amount that is a CO₂ emission amount per unit weight of a second raw material; and
a control device configured to calculate the CO₂ emission amount of the product based on a CO₂ emission amount to be calculated from the first CO₂ emission amount and from a weight of the first raw material used to produce the product, and a CO₂ emission amount to be calculated from the second CO₂ emission amount and from a weight of the second raw material used to produce the product, wherein
the product is produced by using the first raw material and the second raw material that are the same kind of raw materials,
the first raw material is not a recycled product produced by recycling, and
the second raw material is the recycled product.

2. The management apparatus according to claim 1, wherein the second CO₂ emission amount is calculated based on an amount of energy required to produce the second raw material by recycling.

3. The management apparatus according to claim 2, wherein the control device is configured to calculate the second CO₂ emission amount as zero in a case where the recycling to produce the second raw material does not involve CO₂ emission.

4. A management method for managing a CO₂ emission amount to be emitted by producing a product, the management method comprising:
reading out a first CO₂ emission amount that is a CO₂ emission amount per unit weight of a first raw material and a second CO₂ emission amount that is a CO₂ emission amount per unit weight of a second raw material; and
calculating the CO₂ emission amount of the product based on a CO₂ emission amount to be calculated from the first CO₂ emission amount and from a weight of the first raw material used to produce the product, and a CO₂ emission amount to be calculated from the second CO₂ emission amount and from a weight of the second raw material used to produce the product, wherein
the product is produced by using the first raw material and the second raw material that are the same kind of raw materials,
the first raw material is not a recycled product produced by recycling, and
the second raw material is the recycled product.
